(19) United States
(12) Patent Application Publication
(10) Pub. No.: US 2021/0307306 A1
(43) Pub. Date: Oct. 7, 2021

(54) Fishing Weight

(71) Applicant: Jean-Paul Di Giulio, Brampton (CA)

(72) Inventor: Jean-Paul Di Giulio, Brampton (CA)

(21) Appl. No.: 16/840,360

(22) Filed: Apr. 4, 2020

(51) Int. Cl. A01K 85/01; A01K 95/00

(52) U.S. Cl. CPC A01K 85/01; A01K 95/00

(57) ABSTRACT

A fishing weight for use on a fishing line submerged in water is disclosed. The fishing weight consists of a hollow body having opposite first and second ends, walls and a hollow interior. At least one aperture is formed on the walls to permit the water to pass through the aperture and through the hollow interior. The first end is closed off apart from a small opening dimensioned to receive the fishing line and the second end has a larger opening which can be closed off by a cap configured to permit the fishing line to pass through. The hollow interior can hold an attractant, the attractant being selected from the group of attractants comprising rattle beads, bubble generators and scent releasers.

### CROSS-REFERENCE TO RELATED APPLICATION

This application claims priority from provisional application Ser. No. 62/830,790 filed Apr. 8, 2019, the entirety of which is incorporated herein by reference.

### BACKGROUND OF THE INVENTION

Bullet weights are a type of fishing weight where the line is passed through the weight and secured on the line by knots, beads or by line holding features formed in the weight itself. These weights are usually solid objects which have a bore through which the fishing line is passed. These weights are often placed in front of a lure or baited hook to keep the lure/bait positioned in the water for maximum effectiveness.

Weights and lures with attractants such as color and sound makers such as rattles and blades have been available for some time, but due to a variety of factors, they are either not convenient to use or they tend not to be very effective. Live bait or cut bait adds additional attractants such as smell, taste and texture, but these are attractants are difficult to incorporate into weights and lures and are therefore usually excluded. A fishing weight which allows for ease of use as well as providing additional attractants is therefore desirable.

### SUMMARY OF THE INVENTION

In accordance with one aspect of the present invention, the invention consists of a fishing weight for use on a fishing line submerged in water. The fishing weight consists of an elongated tubular body having opposite first and second ends, walls and a hollow interior. At least one aperture is formed on the walls to permit the water to pass through the aperture and through the hollow interior. The first end is closed off apart from a small opening dimensioned to be slightly wider than a width of the fishing line and the second end has an opening. The fishing weight includes a cap which is removably attached to the second end to close off the opening in the second end. The cap has a small passage dimensioned to permit the fishing line to pass through, the hollow interior being sufficiently large to hold an attractant, the attractant being selected from the group of attractants comprising rattle beads, bubble generators and scent releasers.

In accordance with another aspect of the present invention, herein is disclosed a fishing weight for use on a fishing line submerged in water, the fishing weight consisting of a hollow body having opposite first and second ends, walls and a hollow interior. At least one aperture is formed on the walls to permit the water to pass through the aperture and through the hollow interior. The first end is closed off apart from a small opening dimensioned to be slightly wider than a width of the fishing line. The second end has an opening and the fishing weight is provide with a cap which is removably attached to the second end to close off the opening in the second end. The cap has a small passage dimensioned to permit the fishing line to pass through. The hollow interior is sufficiently large to hold an attractant, the attractant being selected from the group of attractants comprising rattle beads, bubble generators and scent releasers.

In accordance with another aspect of the present invention, herein is disclosed a fishing weight for use on a fishing line submerged in water, the fishing weight including a hollow body having opposite first and second ends, walls and a hollow interior, with at least one aperture being formed on the walls to permit the water to pass through the aperture and through the hollow interior. The first end of the hollow body is closed off apart from a small opening dimensioned to be slightly wider than a width of the fishing line. The second end of the hollow body has an opening, a cap being removably attached to the second end to close off the opening in the second end. The cap is configured to permit the fishing line to pass out of the second end while the cap is attached to the second end. The hollow interior of the hollow body is sufficiently large to hold an attractant, the attractant being selected from the group of attractants comprising rattle beads, bubble generators and scent releasers.

### DESCRIPTION OF THE DRAWINGS

FIG. 1 is a side view of a fishing weight made in accordance with the present invention and showing the weight loaded with a ball bearing and fishing line.

FIG. 2 is a long sectional view of the fishing weight shown in FIG. 1.

In the drawings like characters of reference indicate corresponding parts in the different figures.

### DETAILED DESCRIPTION OF THE INVENTION

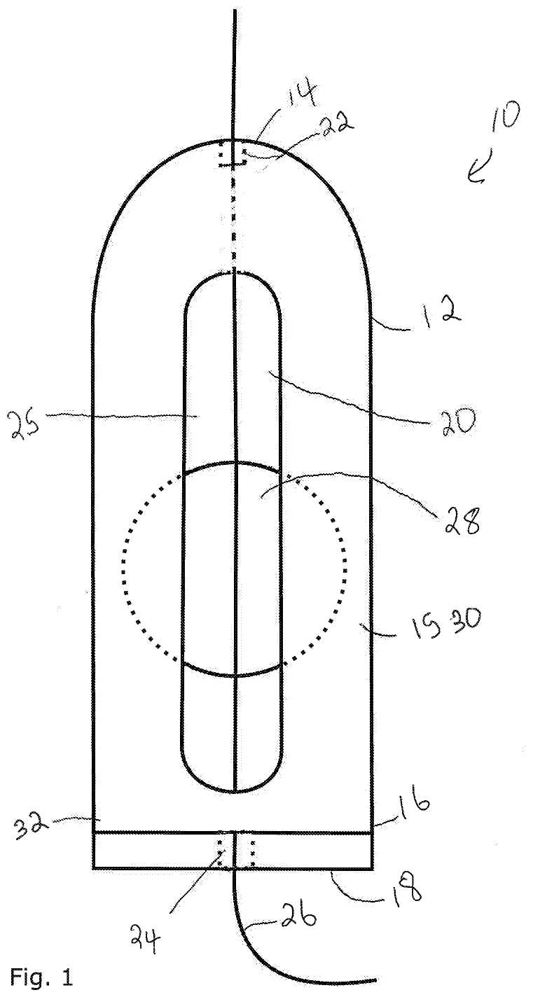

Referring firstly to FIG. 1, a weight made in accordance with the present invention is shown generally as item 10 and consists of a hollow body 12 preferably having rounded end 14 and terminal end 16, opening 32 and walls 30. Cap 18 is removably attached to terminal end 16 to close off opening 32 at the terminal end. Body 12 has elongated openings 20 which are formed in the walls 30 of body 12 and permit water to flow through the interior of body 12 and out into the environment. End 14 is provided with a passage 22 and cap 18 is provided with a passage 24 which is dimensioned to permit fishing line 26 to pass through cap 18 and end 14 of body 12. Preferably passages 22 and 24 are coaxially aligned. Body 12 is preferably hollow having interior space 25 which is in communication with the surrounding environment by elongated openings 20. Preferably body 12 has several elongated openings 20 which are oriented parallel to each other and extend between ends 14 and 16. Body 12 is preferably made of a heavy material which is corrosion resistant such as brass or lead. Cap 18 may also be made of brass or lead or it may be made of a plastic or rubber material. Interior space 25 and opening 32 are sufficiently large to permit attractants 28 to be inserted and retained in the interior of body 12. Apertures 20 are dimensioned to prevent attractant 28 from passing through. Attractant 28 can include such things as scent releasing agents such as scented polymer/gel beads or naturally scented things such as natural bait. Attractant 28 can also include other fish attracting items such as effervescent (bubble generating) packets, metallic beads for sound/vibration generation or light emitting objects. In the example illustrated in FIG. 1, attractant 28 is a metal bead which moves back and forth and up and down in space 25 to generate sound and vibration. Of course, interior space 25 is preferably dimensioned to be sufficiently large relative to attractant 28 to permit the attractant to rattle against walls 30.

It will be appreciated that attractant 28 is exposed to the water thanks to elongated openings 20. The elongated openings allow water to act on attractant 28, allowing the attractant to release scent, release bubbles or vibrate directly in the water, as the case may be. In the present example, since attractant 28 is a metal bead, the bead generates sound and vibrations directly into the water as it moves in body 12. It will be further appreciated that since metal bead 28 is surrounded by water, the vibrations and sounds it generates will be significantly different that the sounds or vibrations generated by beads in an air-filled rattle. It is anticipated that the action of a metal bead in body 12 filled with water will more closely simulate the sort of vibrations and sounds generated by wounded live bait than beads in an air filled rattle.

Fishing line 26 is threaded through body 12 and attractant 28 can be inserted into body 12 such that the fishing line passes around the attractant. In some cases, the fishing line can pass through the attractant in the event the attractant consists of a soft material or in the event the attractant has a passage configured to permit the line to pass through.

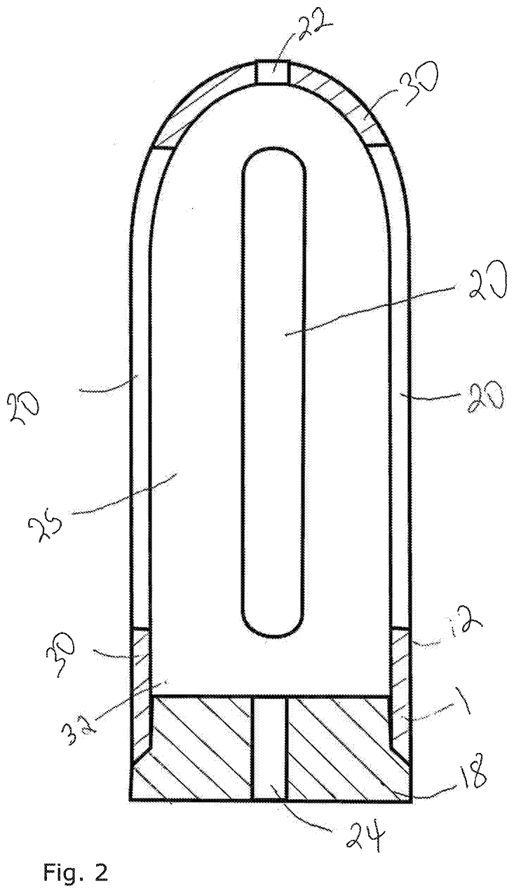

Referring now to FIG. 2, end 16 of body 12 is opened allowing interior space 25 to be accessed simply by removing cap 18 to uncover opening 32. Cap 18 may be threaded onto end 16, or the cap may be dimensioned to fit onto end 16 by friction. If cap 18 is made of a plastic or rubber like material, it can be inserted into end 16 much like a cork into a bottle. If cap 18 is made of plastic or rubber, then it need not have aperture 24 and can simply pinch fishing line 26 against wall 30 adjacent opening 32 when the cap is inserted into the opening.

Body 12 has walls 30 which are provided with the elongated openings 20. Openings 20 can be any shape, but preferably they are formed as elongated slots which extend between the opposite ends of hollow body 12. Preferably between two to four openings are provided allowing easy water flow through interior 25 when the weight is submerged. If openings 20 are formed as elongated slots then the volume of water circulating between the openings and interior space 25 can be maximized while allowing the dimensions of the openings to keep attractant 28 within the interior space.

Hollow body 12 is preferably formed as a hollow tube having a rounded or “bullet shaped” first end; however, body 12 can be egg shaped, spherical, or oblong. Being bullet shaped permits the fishing weight to be more snag proof preventing the fishing weight from being snagged on weeds or debris in the water.

Opening 24 in cap 18 permits the fishing weight to be mounted onto fishing line 26 by passing the fishing line through the fishing weight. In some circumstances, it would preferable to permit the fishing weight to slide along fishing line 26 and to keep the fishing weight positioned by means of knots in the fishing line, or by other means. Alternatively, cap 18 can be configured such that the cap can clamp onto fishing line 26 to hold the fishing weight firmly on the fishing line. This can be accomplished by making cap 18 out of a soft deformable metal such as lead or a lead/tin alloy allowing the cap to be deformed to close off opening 24. Alternatively, cap 18 may be made of a rubber/plastic material which is deformable, soft and resilient permitting the cap to be inserted into opening 32 like a cork in a bottle. If cap 18 is made of a sufficiently soft, deformable and resilient material like rubber or plastic, then fishing line 26 may be passed through opening 24 between wall 30 and a peripheral edge of cap 18 allowing the cap to pinch the fishing line against the wall.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims

Therefore, what is claimed is:

1. A fishing weight for use on a fishing line submerged in water, the fishing weight comprising an elongated tubular body having opposite first and second ends, walls and a hollow interior, at least one aperture being formed on the walls to permit the water to pass through the aperture and through the hollow interior, the first end being closed off apart from a small opening dimensioned to be slightly wider than a width of the fishing line, the second end having an opening, a cap being removably attached to the second end to close off the opening in the second end, the cap having a small passage dimensioned to permit the fishing line to pass through, the hollow interior being sufficiently large to hold an attractant, the attractant being selected from the group of attractants comprising rattle beads, bubble generators and scent releasers.

2. The fishing weight of claim 2 wherein the aperture comprise at least one elongated slot extending along the elongated tubular body between the first and second end.

3. The fishing weight of claim 1 wherein there are a plurality of apertures each comprising an elongated slot extending along the elongated tubular body between the first and second end, the elongated slots being parallel to each other.

4. The fishing weight of claim 1 wherein the cap is configured to hold the fishing line in place relative to the fishing weight when the cap is attached to the fishing weight and the fishing line is passed through the fishing weight.

5. The fishing weight of claim 1 wherein the attractant, the hollow interior and the aperture are dimensioned such that the attractant can move around within the hollow interior but cannot pass through the aperture, the opening of the second end being dimensioned to permit the attractant to be inserted or removed from the hollow interior when the cap is removed from the second end.

6. The fishing weight of claim 5 wherein the hollow interior, the aperture and the attractant are dimensioned such that the attractant can move sufficiently to permit the attractant to rattle against the walls of the fishing weight.

7. The fishing weight of claim 5 wherein the aperture is dimensioned such that bubbles can pass through the aperture.

8. A fishing weight for use on a fishing line submerged in water, the fishing weight comprising a hollow body having opposite first and second ends, walls and a hollow interior, at least one aperture being formed on the walls to permit the water to pass through the aperture and through the hollow interior, the first end being closed off apart from a small opening dimensioned to be slightly wider than a width of the fishing line, the second end having an opening, a cap being removably attached to the second end to close off the opening in the second end, the cap having a small passage dimensioned to permit the fishing line to pass through, the hollow interior being sufficiently large to hold an attractant, the attractant being selected from the group of attractants comprising rattle beads, bubble generators and scent releasers.

9. The fishing weight of claim 8 wherein the attractant, the hollow interior and the aperture are dimensioned such that the attractant can move around within the hollow interior but cannot pass through the aperture, the opening of the second end being dimensioned to permit the attractant to be inserted or removed from the hollow interior when the cap is removed from the second end.

10. The fishing weight of claim 9 wherein the aperture comprises a plurality of apertures each of which is dimensioned to prevent the attractant to pass through.

11. The fishing weight of claim 8 wherein the hollow body is elongated.

12. The fishing weight of claim 11 wherein the aperture is formed as an elongated slot extending along the hollow body between the first and second ends of the hollow body.

13. The fishing weight of claim 11 wherein the aperture is formed as a plurality of elongated slots extending parallel to each other along the hollow body between the first and second ends.

14. The fishing weight of claim 8 wherein the cap is configured to tightly secure the fishing line such that the fishing weight is held in place on the fishing line.

15. A fishing weight for use on a fishing line submerged in water, the fishing weight comprising a hollow body having opposite first and second ends, walls and a hollow interior, at least one aperture being formed on the walls to permit the water to pass through the aperture and through the hollow interior, the first end being closed off apart from a small opening dimensioned to be slightly wider than a width of the fishing line, the second end having an opening, a cap being removably attached to the second end to close off the opening in the second end, the cap configured to permit the fishing line to pass out of the second end while the cap is attached to the second end, the hollow interior being sufficiently large to hold an attractant, the attractant being selected from the group of attractants comprising rattle beads, bubble generators and scent releasers.

16. The fishing weight of claim 15 wherein the aperture is formed as a plurality of elongated slots extending parallel to each other along the hollow body between the first and second ends.

17. The fishing weight of claim 15 wherein the attractant, the hollow interior and the aperture are dimensioned such that the attractant can move around within the hollow interior but cannot pass through the aperture, the opening of the second end being dimensioned to permit the attractant to be inserted or removed from the hollow interior when the cap is removed from the second end.

18. The fishing weight of claim 15 wherein the cap is configured to tightly secure the fishing line such that the fishing weight is held in place on the fishing line.

19. The fishing weight of claim 15 wherein the hollow interior, the aperture and the attractant are dimensioned such that the attractant can move sufficiently to permit the attractant to rattle against the walls of the fishing weight.

20. The fishing weight of claim 15 wherein the aperture is dimensioned such that bubbles can pass through the aperture.
